(19) United States
(12) Patent Application Publication
(10) Pub. No.: US 2010/0087233 A1
(43) Pub. Date: Apr. 8, 2010

(54) EXTENDABLE SLIDING MODULE AND MOBILE TERMINAL HAVING THE SAME

(75) Inventors: Jae Chul JIN, Hwaseong-si (KR); Ki Taek KIM, Yongin-si (KR); Yun Cheol KANG, Gunpo-si (KR); Jeong Hun SEO, Suwon-si (KR); Seon Hee SHIM, Suwon-si (KR); Young-Ki KIM, Seongnam-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/482,170

(22) Filed: Jun. 10, 2009

(30) Foreign Application Priority Data
Oct. 6, 2008 (KR) 0054022/2008

(51) Int. Cl. H04M 1/00

(52) U.S. Cl. 455/575.4

(57) ABSTRACT

An extendable sliding module is disclosed, including a main body, a plurality of plates disposed at an upper part thereof and movable in a longitudinal direction thereof, a guide groove formed in at least one of opposite side surfaces of the main body and extending in the longitudinal direction thereof, and a hinge having one side slidably housed in the guide groove and the other side attached to the plurality of plates, and being extendable and retractable by a sliding movement between a first retracted state in which the plurality of plates are disposed to contact each other in the longitudinal direction of the main body and a second extended state in which the plurality of plates are disposed at a predetermined separation from each other.

### CLAIMS OF PRIORITY

This application claims priority to an application entitled “EXTENDABLE SLIDING MODULE AND MOBILE TERMINAL HAVING THE SAME” filed in the Korean Intellectual Property Office on Jun. 10, 2008 and assigned Serial No. 10-2008-0054022, the contents of which are incorporated herein by reference.

### BACKGROUND OF THE INVENTION

1. Field of the Invention

The present invention relates generally to an extendable sliding module, and more particularly, to an extendable sliding module and a mobile terminal having the same that can expose an upper surface of a main body positioned at a lower part of the module by slidably extending plates positioned at an upper part of the module to have an identical separation.

2. Description of the Related Art

With the development of a semiconductor integrated circuit technology and information and communication technology, various mobile terminals and Personal Digital Assistants (PDAs) are now very widely used. Accordingly, various demands of users have arisen and competition among manufacturers for meeting user demands has significantly increased. As such, mobile terminals that can conveniently provide additional functions are being continuously developed.

For example, in addition to conventional intrinsic functions such as communication and message transmission and reception, various functions that have been integrated with mobile terminals include multimedia player functions such as photographing, game and music playing, digital broadcasting reception, a wireless Internet function, and a short range wireless communication function such as Bluetooth®. Also available are smart phones and Personal Data Assistant (PDA) phones for embodying an information processing function of a Personal Computer (PC) in the mobile terminal.

The mobile terminal has a keypad module for inputting a signal according to a user's manipulation. In general, the keypad module provides alphanumeric keys, and occasionally a function key and a navigation key. The keypad module has various forms depending on the type, manufacturer, and model of the mobile terminal. However, as various functions are added to the mobile terminal, the distinctions between a mobile terminal and a PC are decreasing. As such, there is a need for a new keypad module as the input unit of the mobile terminal.

Since the mobile terminal has a portable size, the input unit of the mobile terminal has various limitations caused by design and human body engineering requirements as well as a limitation in space. Under such limitations, it is difficult to provide an input unit that can perform various functions in consideration of user convenience.

### SUMMARY OF THE INVENTION

The present invention has been made in view of the above problems, and provides an extendable sliding module and a mobile terminal having the same that enable convenient key manipulation by securing space between key plates.

The present invention provides an extendable sliding module and a mobile terminal having the same that enable various visual appearances of the mobile terminal.

The present invention provides an extendable sliding module and a mobile terminal having the same that extend a plurality of plates at a separation by sliding movement.

In accordance with the present invention, an extendable sliding module includes a main body, a plurality of plates disposed at an upper part of the main body and movable in a longitudinal direction thereof, a guide groove formed in at least one of opposite side surfaces of the main body and extending in the longitudinal direction thereof, and a hinge having one side slidably housed in the guide groove and the other side attached to the plurality of plates, and extendable and retractable by a sliding movement between a first retracted state in which the plurality of plates are disposed to contact each other in the longitudinal direction of the main body and a second extended state in which the plurality of plates are disposed at a predetermined separation from each other.

The hinge includes a bar having a plurality of first members, each attached at one side to one of the plurality of plates, and a plurality of second members disposed within the plurality of first members, and a plurality of links rotatably connected by a plurality of pins, each link having one end slidably housed in the guide groove and the other end attached to one of the plurality of first members, wherein when the plurality of plates move between the first state and the second state, the bar and the plurality of links extend and retract in the movement direction by an interlock operation, and the bar moves in a direction perpendicular to the movement direction according to the extension and retraction of the plurality of links.

Each of the plurality of first members has an inwardly protruding first latch jaw formed at both ends thereof, and each of the plurality of second members has an outwardly protruding second latch jaw formed at both ends thereof, and the first latch jaw and the second latch jaw latch with each other when the plurality of plates slides to the second state.

Each of the plurality of first members has a hole in an outer surface thereof, and the plurality of links are attached to the first members by coupling the pin at one end of the link to the hole of the corresponding first member.

The extendable sliding module further includes a plurality of spring members for connecting the plurality of second members, a groove formed at the inside of one of the plurality of plates, and an elastic deformable protrusion formed in at least one of both side surfaces of the main body, wherein when the module slides to the second state, the protrusion connects to the groove, and when the protrusion is separated from the groove, the module slides to the first state by an elastic restoring force of the plurality of second members.

The hinge includes a plurality of first members, each having one side slidably housed in the guide groove and the other side attached to one of the plurality of plates, and a plurality of second members disposed within the plurality of first members, wherein the plurality of second members are enclosed by the plurality of first members in the first state and are exposed between the plurality of first members in the second state.

Each of the plurality of first members has an inwardly protruding first latch jaw formed at both ends thereof, and each of the plurality of second members has an outwardly protruding second latch jaw formed at both ends thereof The first latch jaw and the second latch jaw latch with each other when the plurality of plates slides to the second state.

The extendable sliding module further includes a groove formed at the inside of one of the plurality of plates, and an elastic deformable protrusion formed in at least one of both side surfaces of the main body, wherein the hinge includes a plurality of first members, each having one side slidably housed in the guide groove and the other side attached to one of the plurality of plates, and a plurality of second members for connecting the plurality of first members and having an elastic force. When the module slides to the second state, the protrusion connects to the groove, and when the protrusion is separated from the groove, the module slides to the first state by an elastic restoring force of the plurality of second members.

The module is a keypad module, and each of the plurality of plates is a key plate having a quantity of key detection units.

In accordance with the present invention, a mobile terminal includes a first main body, a second main body slidably disposed at an upper part of the first main body, a plurality of key plates connected to the second main body, a guide groove formed in at least one of opposite side surfaces of the first main body and extending in the longitudinal direction thereof, and a hinge having one side slidably housed in the guide groove and the other side attached to the plurality of key plates, and extendable and retractable by a sliding movement between a first retracted state in which the plurality of key plates are disposed to contact each other and a second extended state in which the plurality of key plates are disposed at a predetermined separation from each other.

The hinge includes a bar having a plurality of first members, each attached at one side to one of the plurality of key plates, and a plurality of second members disposed within the plurality of first members, and a plurality of links rotatably connected by a plurality of pins, each link having one end slidably housed in the guide groove and the other end attached to one of the plurality of first members, wherein when the plurality of key plates moves between the first state and the second state, the bar and the plurality of links extend and retract in the movement direction by an interlock operation, and the bar moves in a direction perpendicular to the movement direction according to the extension and retraction of the plurality of links.

Each of the plurality of first members has an inwardly protruding first latch jaw formed at both ends thereof, and each of the plurality of second members has an outwardly protruding second latch jaw formed at both ends thereof, and the first latch jaw and the second latch jaw latch with each other when the plurality of key plates slides to the second state.

Each of the plurality of first members has a hole in an outer surface thereof, and the plurality of links are attached to the first members by coupling the pin at one end of the link to the hole of the corresponding first member.

The hinge includes a plurality of first members, each having one side slidably housed in the guide groove and the other side attached to one of the plurality of key plates, and a plurality of second members disposed within the plurality of first members, wherein the plurality of second members are enclosed by the plurality of first members in the first state and are exposed between the plurality of first members in the second state.

Each of the plurality of first members has an inwardly protruding first latch jaw formed at both ends thereof, and each of the plurality of second members has an outwardly protruding second latch jaw formed at both ends thereof, and the first latch jaw and the second latch jaw latch with each other when the plurality of key plates slide to the second state.

The first main body has a key display unit in an upper surface thereof, and the key display unit is exposed between the plurality of key plates in the second state.

### BRIEF DESCRIPTION OF THE DRAWINGS

The objects, features and advantages of the present invention will be more apparent from the following detailed description in conjunction with the accompanying drawings, in which:

FIG. 1 illustrates a mobile terminal according to the present invention;

FIG. 2A illustrates a retracted state of an extendable sliding module according to a first embodiment of the present invention;

FIG. 2B illustrates an extended state of the module of FIG. 2A;

FIG. 3A illustrates a hinge structure in the retracted state of the module of FIG. 2A;

FIG. 3B illustrates a hinge structure in the extended state of the module of FIG. 2A;

FIG. 4A illustrates a bar structure in the retracted state of the module of FIG. 2A;

FIG. 4B illustrates the bar structure in the extended state of the module of FIG. 2A;

FIG. 5 illustrates moving directions of members when sliding the module of FIG. 2A;

FIGS. 6A and 6B illustrates an extendable sliding module according to a second embodiment of the present invention;

FIG. 7 illustrates an extended state of an extendable sliding module according to a third embodiment of the present invention;

FIG. 8 illustrates an extended state of an extendable sliding module according to a fourth embodiment of the present invention;

FIG. 9A illustrates a retracted state of a slide type mobile terminal having an extendable sliding module according to a fifth embodiment of the present invention;

FIG. 9B illustrates an extended state of the slide type mobile terminal of FIG. 9A; and

FIG. 9C is a side view illustrating the extended state of the slide type mobile terminal of FIG. 9A.

### DETAILED DESCRIPTION OF THE PREFERRED EMBODIMENTS

Hereinafter, preferred embodiments of the present invention are described in detail with reference to the accompanying drawings. The same reference numbers are used throughout the drawings to refer to the same or similar parts. The views in the drawings are schematic only, and are not intended to be to scale or correctly proportioned. Detailed descriptions of well-known functions and structures incorporated herein may be omitted for the sake of clarity and conciseness.

In the following description, a mobile phone is exemplified for the sake of convenience. However, the present invention is not limited thereto, as a mobile terminal according to the preferred embodiments of the present invention may include information and communication appliances and multimedia appliances, such as a mobile phone, wired/wireless phone, Portable Multimedia Player (PMP), Personal Digital Assistant (PDA), and smart phone, and associated applications.

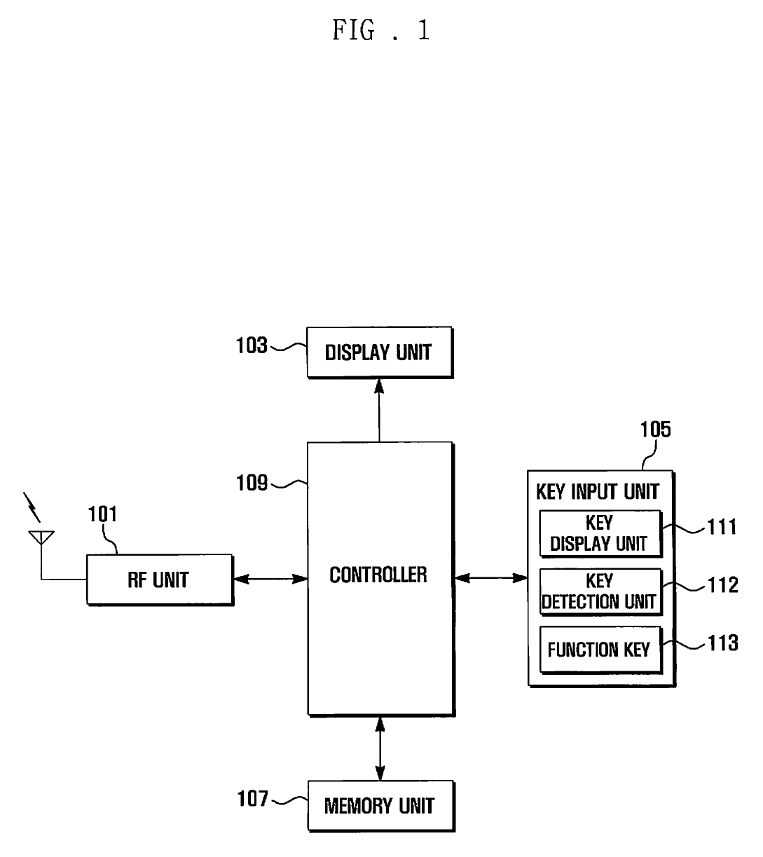

FIG. 1 illustrates a mobile terminal according to the present invention.

Referring to FIG. 1, the mobile terminal includes a Radio Frequency (RF) unit 101, display unit 103, key input unit 105, memory unit 107, and controller 109.

The RF unit 101 performs a wireless communication function of the mobile terminal, and includes an RF transmitter for up-converting a frequency of a signal to be transmitted and amplifying the signal, and an RF receiver for low-noise amplifying a received signal and down-converting a frequency of the signal. The present invention can also be applied to a terminal having no RF unit, such as a terminal having no phone call function.

The display unit 103 visually displays various information related to a state and operation of the mobile terminal. The display unit 103 can use a Liquid Crystal Display (LCD), and in this case, the display unit 103 includes an LCD controller and an LCD display element. If the LCD has a touch screen, the display unit 103 can be used as an input unit.

The key input unit 105 is used for inputting a user's manipulation signal for controlling operation of the mobile terminal. The key input unit 105 is a keypad module and includes a key display unit 111, key detection unit 112, and function key 113.

The key display unit 111 includes alphanumeric keys, and special symbols (e.g., * and #), and has an aspect ratio of 3:4, 4:3, or 5:4. The alphanumeric key may have a QWERTY key layout such as a conventional Personal Computer (PC) keyboard.

The key detection unit 112 is in a locked state when the keypad module is in a closed position, and the key detection unit 112 is in an operational state when the keypad module is opened by a sliding movement. The key detection unit 112 includes a touch sensor and enables a user to perform a desired manipulation by touching. When a touch occurs through the touch sensor, the key detection unit 112 detects a change in a value of a physical characteristic, for example resistance and capacitance, and thereby detects occurrence of the touch. The key detection unit 112 further includes a signal converter that converts a change in a value of a physical characteristic to a touch signal.

The function key 113 may be a communication key (dial key or talk key), power key (power on/off key), select key (or OK key), cancel key (or back key), and additional function keys necessary for performing functions of the mobile terminal. A navigation key (not shown) is for performing functions such as menu search in four directions, cursor movement, and scrolling.

The memory unit 107 stores programs and information necessary for operating the mobile terminal, such as a program for locking a function of the key input unit 105 before the module slides open, releasing the lock of a function of the key input unit 105 after the module slides open, and illuminating the key display unit 110 and the function key 113.

The controller 109 controls basic operations of units of the mobile terminal, such as the locking and release of the key input unit 105 according to sliding movement of the module. The controller 109 controls to detect a touch of the key detection unit 112 and the function key 113, to perform a function requested by the user, and to display the function in the display unit 103.

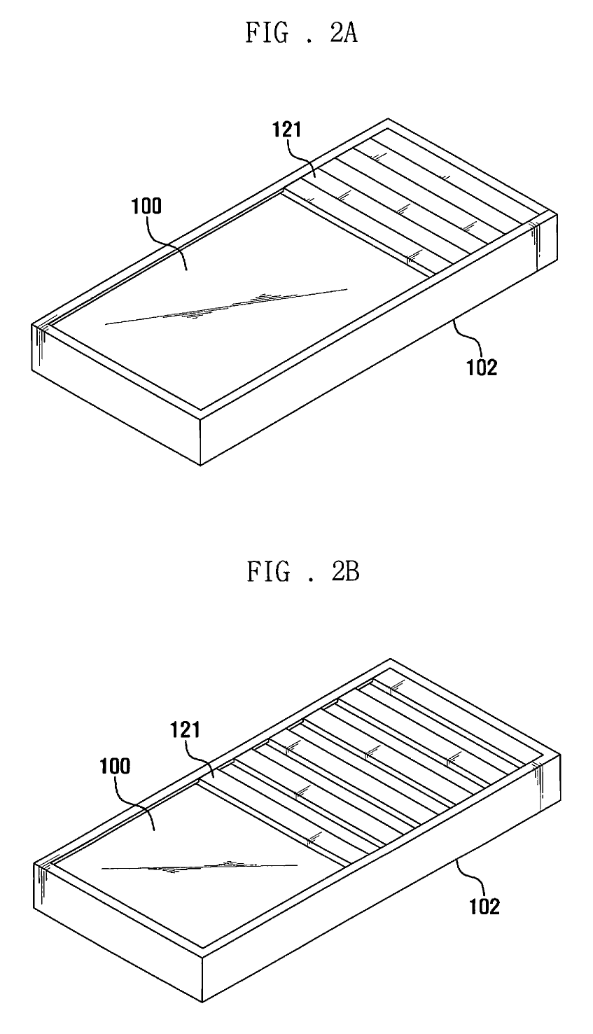

FIG. 2A illustrates a retracted state of an extendable sliding module according to a first embodiment of the present invention, and FIG. 2B illustrates an extended state of the module of FIG. 2B.

Referring to FIGS. 2A and 2B, a keypad module according to the first embodiment includes a main body 100, a housing 102 for housing the main body 100, and a plurality of plates 121 slidably disposed in an upper part of the main body 100. The main body 100 has a key display unit in an upper surface thereof. The plurality of plates 121 includes a key detection unit (not shown) and a function key (not shown). When the module is in a retracted state, as shown in FIG. 2A, the plurality of plates 121 are disposed in contact with each other, and when the module is in an extended state, as shown in FIG. 2B, the plurality of plates 121 are disposed at a predetermined separation, and in this case, the main body 100 is exposed through the spaces between the plurality of plates 121.

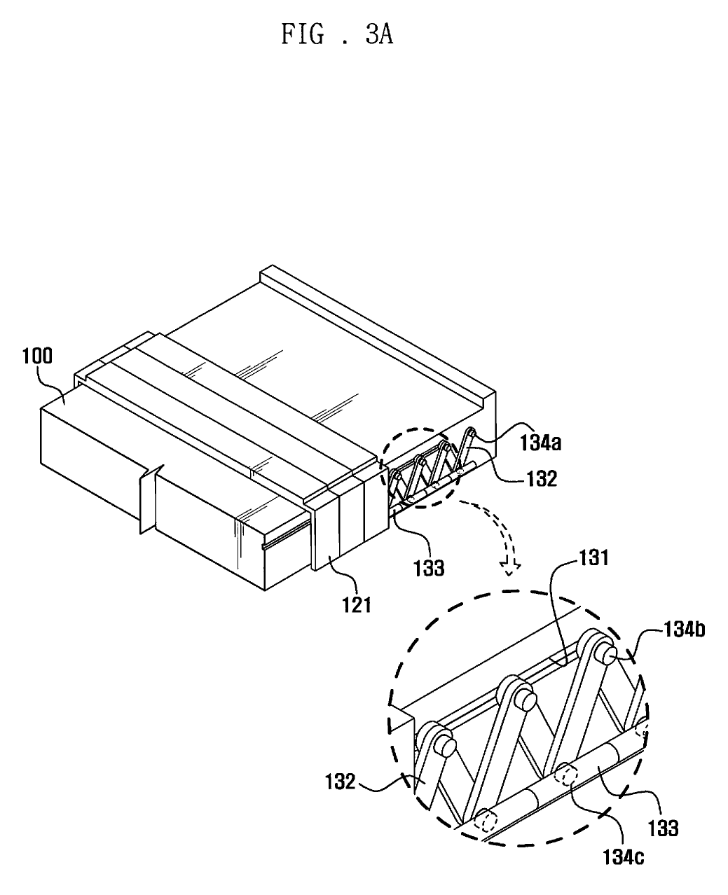

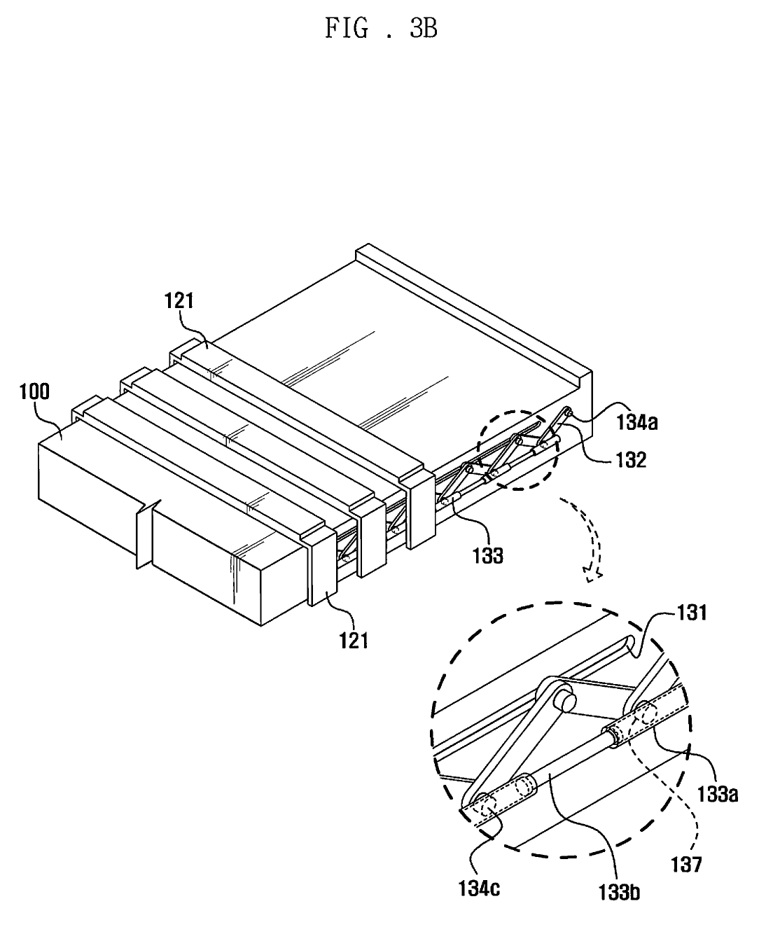

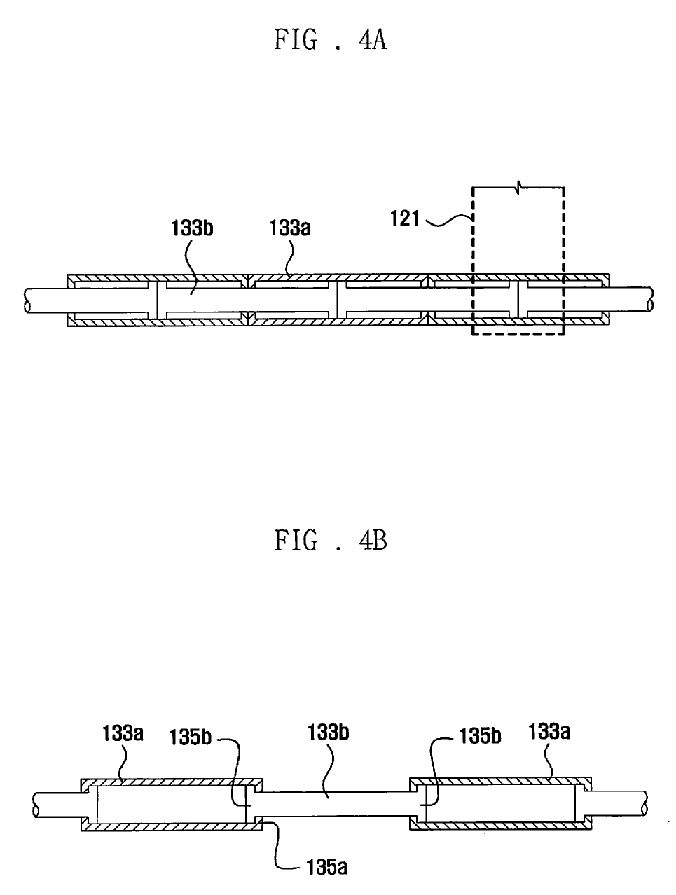

FIG. 3A illustrates a hinge structure in the retracted state of the module of FIG. 2A, and FIG. 3B illustrates a hinge structure in the extended state of the module of FIG. 2A.

Referring to FIGS. 3A and 3B, the hinge structure is formed in a side surface of the main body 100. The hinge structure may be formed in both side surfaces, or in only one side surface, of the main body 100. When the hinge structure is formed in both side surfaces of the main body 100 and the module extends, the plurality of plates 121 can be extended to have a more constant separation.

The hinge structure of the module includes a long, narrow guide groove 131, a plurality of links 132 rotatably connected by a plurality of pins 134, and bars 133 that can be extended and retracted in a lengthwise direction of the main body 100.

Each end of each of the plurality of links 132 is connected to an adjacent one of the links 132 by one of the plurality of pins 134. An outermost pin 134a connected to the outermost link of the plurality of links 132 is fixed to the main body 100, and the pins 134b for connecting the upper ends of the plurality of links 132 are slidably housed in the guide groove 131. Pins 134c for connecting the lower ends of the plurality of links 132 are attached to the bars 133.

The bar 133 includes a plurality of first members 133a and a plurality of second members 133b disposed at the inside of the plurality of first members 133a. In FIG. 3B, the plurality of first members 133a and second members 133b have a cylindrical shape, however a shape of the plurality of first members 133a and second members 133b is not limited thereto, and the plurality of first members 133a and second members 133b may have a shape of a polygonal pillar, such as a quadrangular pillar or a triangular pillar.

A plurality of plates 121 are attached to outer surfaces of the plurality of first members 133a, and the pins 134c for connecting the lower ends of the plurality of links 132 are attached to the inner surface of the members 133a. The pins 134c can be attached to the members 133a by various coupling methods, such as bonding or welding, however in the present embodiment, holes 137 are formed penetrating the first members 133a and the pins 134c are fitted into the holes 137 to attach the plurality of first members 133a, as shown in FIG. 3B.

The outer diameter of the plurality of second members 133b is smaller than the inner diameter of the plurality of first members 133a. Therefore, when the module is in a retracted state, the plurality of second members 133b are disposed within the plurality of first members 133a and thus are not exposed, and when the module is in an extended state, the plurality of second members 133b are exposed between the first members 133a.

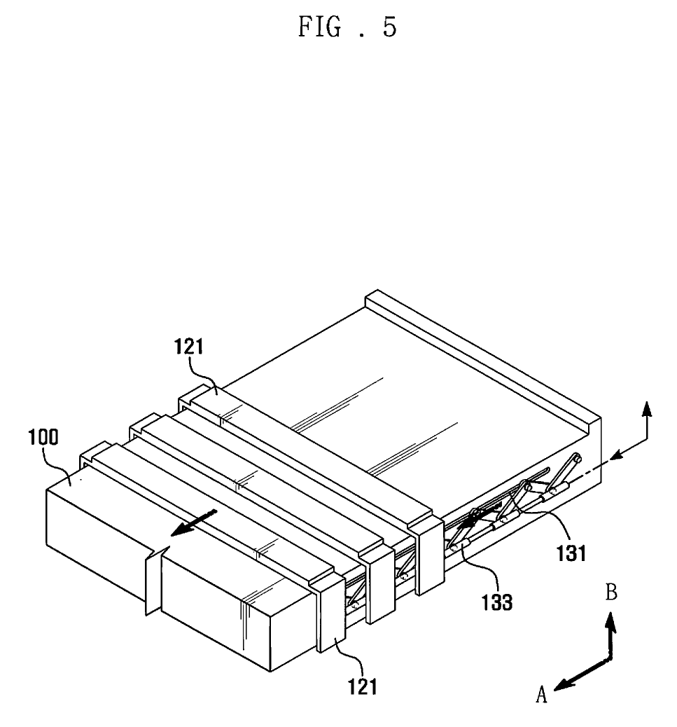

FIG. 4A illustrates a bar structure in the retracted state of the module of FIG. 2A.

Referring to FIG. 4A, when the module is in the retracted state, as the plurality of first cylindrical members 133a contact each other, the plurality of first cylindrical members 133a do not open the plurality of second members 133b disposed at the inside thereof. In this state, the plurality of second members 133b may contact each other.

FIG. 4B illustrates the bar structure in the retracted state of the module of FIG. 2A.

Referring to FIG. 4B, an inwardly protruding first latch jaw 135a is formed at both ends of each of the plurality of first members 133a, and an outwardly protruding second latch jaw 135b is formed at both ends of each of the plurality of second members 133b. When the module extends, the second latch jaw 135b latches to the first latch jaw 135a to prevent excessive extension of the module, and the plurality of second members 133b are thereby prevented from being completely separated from the plurality of first members 133a. The first and second latch jaws 135a and 135b may have various forms, such as a ring shape on the plurality of first and second members 133a and 133b or may be bent inward and outward at each end, thereby preventing excessive extension of the module.

FIG. 5 illustrates moving directions of members when sliding the module of FIG.2A.

Referring to FIG. 5, if a user moves one of the plurality of plates 121 in direction ‘A’, the plurality of plates 121, the plurality of links 132, and the bars 133 move lengthwise in direction ‘A’ through an interlock operation and thus the plurality of plates 121 extend to have a predetermined separation. As the pins 134b connecting the upper ends of the plurality of links 132 slide in the guide groove 131, the height of the plurality of links 132 in direction ‘B’ is reduced and thus the bar 133 moves upwards in direction ‘B’ by an interlock operation.

Restoration to an original retracted state of the module is also performed by an interlock operation of the plurality of plates 121, the plurality of links 132, and the bars 133. That is, if the user moves one of the plurality of plates 121 in a direction opposite to direction ‘A’, the plurality of plates 121, the plurality of links 132, and the bar 133 move in a lengthwise direction opposite to direction ‘A’ by an interlock operation and thus the plurality of plates 121 contact each other. As the pins 134b connecting the upper ends of the plurality of links 132 slide in the guide groove 131 in the direction opposite to direction ‘A’, the height of the plurality of links 132 in direction ‘B’ increases, and thus the bar 133 moves downwards in the direction opposite to direction ‘B’ by an interlock operation.

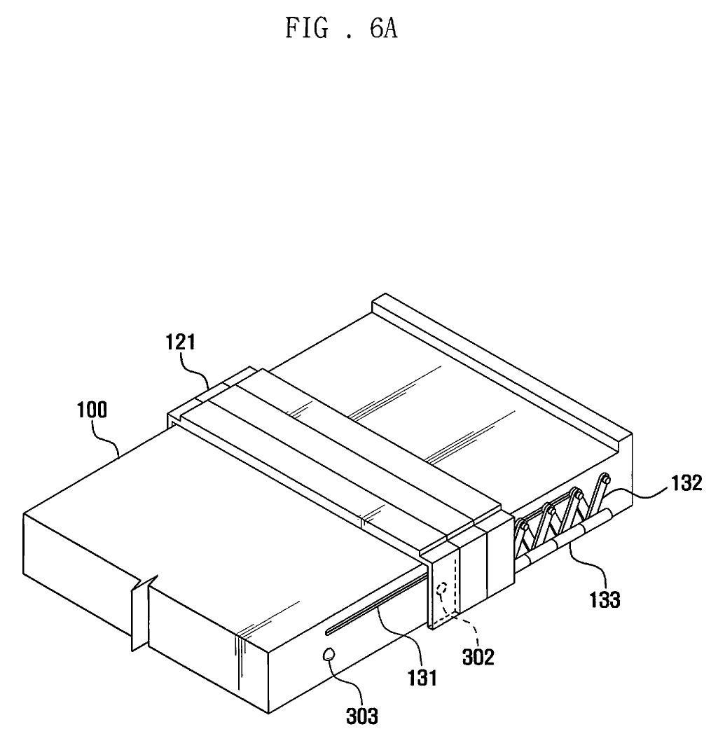

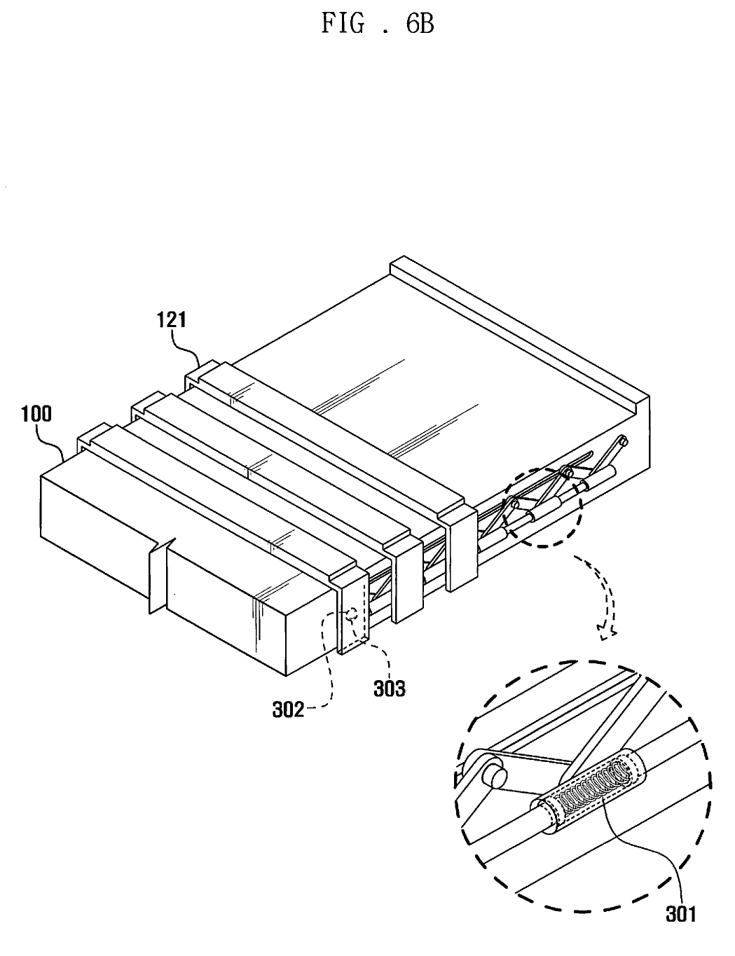

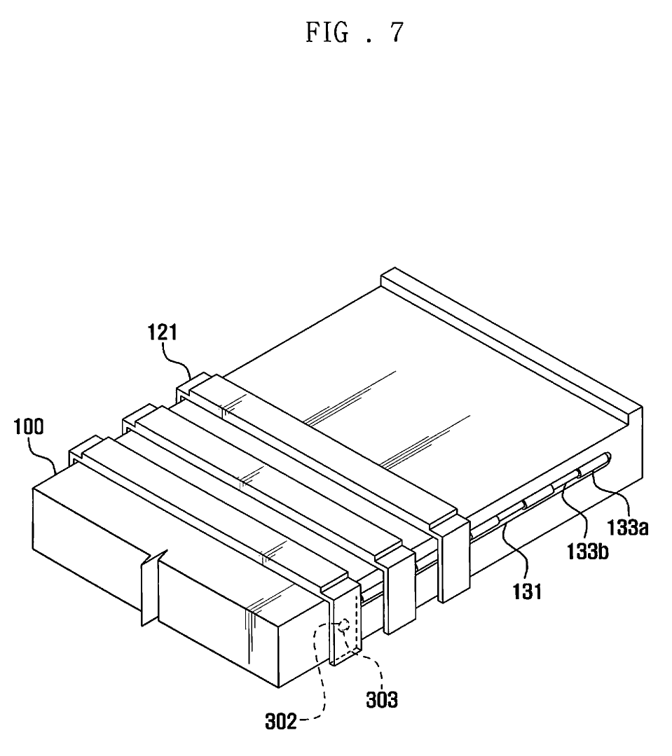

FIGS. 6A and 6B illustrates an extendable sliding module according to a second embodiment of the present invention. In FIGS. 6A and 6B, constituent elements identical to or corresponding to those of the module according to the first embodiment of FIG. 2 are denoted by the same reference numerals and therefore a detailed description thereof is omitted, and only dissimilar constituent elements are described here in detail.

Referring to FIGS. 6A and 6B, the module according to the second embodiment further includes a plurality of spring members 301 for connecting the plurality of second members 133b, a groove 302 formed at the inside of one of the plurality of plates 121, and a protrusion 303 formed in a side surface of the main body 100. The plurality of spring members 301 has an elastically restoring force acting to restore the spring member 301 from an extended state to a normal retracted state.

As the plurality of plates 121 are extended, the protrusion 303 can be deformed according to a pressure exerted thereon by the plate 121 having the groove 302 formed at the inside. As the plurality of plates 121 advances further along the main body 100, the protrusion 303 meets the groove 302 and protrudes into the groove 302, thereby latching the groove 302 and the protrusion 303. As the groove 302 and the protrusion 303 are latched, the plurality of spring members 301 extended by a sliding movement of the module are prevented from returning to an original state and maintain the extended state.

If the user moves the plurality of plates 121 in the direction of the retracted position of the module, the protrusion 303 is depressed by a force exerted thereon by the plate 121 having the groove 302 and thus the protrusion 303 escapes from the groove 302, and the plurality of plates 121 return to the retracted state by an elastically restoring force of the plurality of spring members 301. Therefore, the user can move the plurality of plates 121 from an extended state to a retracted state with a reduced force due to the restoring force of the spring members 301.

In the second embodiment, the plurality of spring members 301 connects the plurality of second members 133b. However, in another embodiment, the plurality of spring members 301 may connect the plurality of first members 133a, which may obviate the plurality of second members 133b.

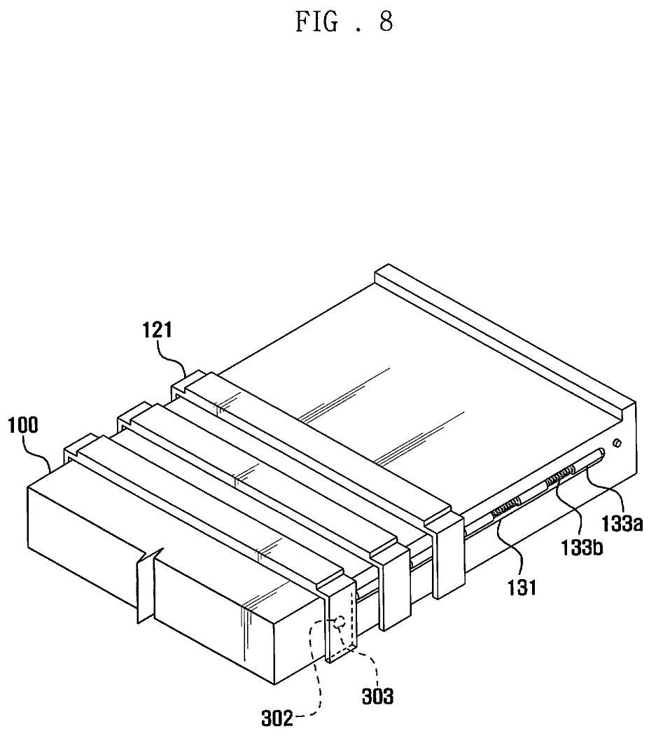

FIG. 7 illustrates an extended state of an extendable sliding module according to the third embodiment of the present invention. In FIG. 7, constituent elements identical to or corresponding to those of the modules according to the first and second embodiments of FIGS. 2 and 6, respectively, are denoted by the same reference numerals and therefore a detailed description thereof is omitted, and only dissimilar constituent elements are described here in detail.

Referring to FIG. 7, the module according to the third embodiment does not have a plurality of links described in the first and second embodiments, and the bars 133 including the plurality of first members 133a and the plurality of second members 133b disposed within the plurality of first members 133a are slidably housed in the guide groove 131. The second member disposed at the end part of the plurality of second members 133b can be fixed to the guide groove 131. Further, each of the plurality of first members 133a may have a pin (not shown) for being slidably housed in the guide groove 131.

In the third embodiment, when the plurality of plates 121 are extended, the plurality of first members 133a move along the guide groove 131 to have a predetermined separation, and the plurality of second members 133b are exposed between the plurality of first members 133a.

FIG. 8 illustrates an extended state of an extendable sliding module according to a fourth embodiment of the present invention. In FIG. 8, constituent elements identical to or corresponding to those of the modules according to the first, second and third embodiments of FIGS. 2, 6, and 7, respectively, are denoted by the same reference numerals and therefore a detailed description thereof is omitted, and only dissimilar constituent elements are described in detail.

Referring to FIG. 8, in a configuration similar to that of the third embodiment of FIG. 7, the module according to the fourth embodiment is formed by connecting the plurality of second members 133b to the plurality of first members 133a with a spring member that can be extended and retracted. When the module is in an extended state, in order to prevent the module from returning to a retracted state by an elastic restoring force of the spring member of each of the plurality of second members 133b, the module has the groove 302 and the protrusion 303 described in the second embodiment of FIG. 6. That is, the groove 302 is formed at the inside of one of the plurality of plates 121, and the protrusion 303 is formed in a side surface of the main body 100.

In the fourth embodiment, as the plurality of plates 121 are extended, the plurality of plates 121 advance along the main body 100 until the protrusion 303 meets the groove 302 and protrudes into the groove 302, thereby latching the groove 302 and the protrusion 303. As the groove 302 and the protrusion 303 are latched, the plurality of second members 133b extended by a sliding movement of the module are prevented from returning to an original state and maintain the extended state.

Further, when the module is in an extended state, if the user moves the plurality of plates 121 in the direction of the retracted position of the module, the protrusion 303 is depressed by a force exerted thereon by the plate 121 having the groove 302 and thus the protrusion 303 escapes from the groove 302, and the plurality of plates 121 return to the retracted state by an elastically restoring force of the spring member of each of the plurality of second members 133b.

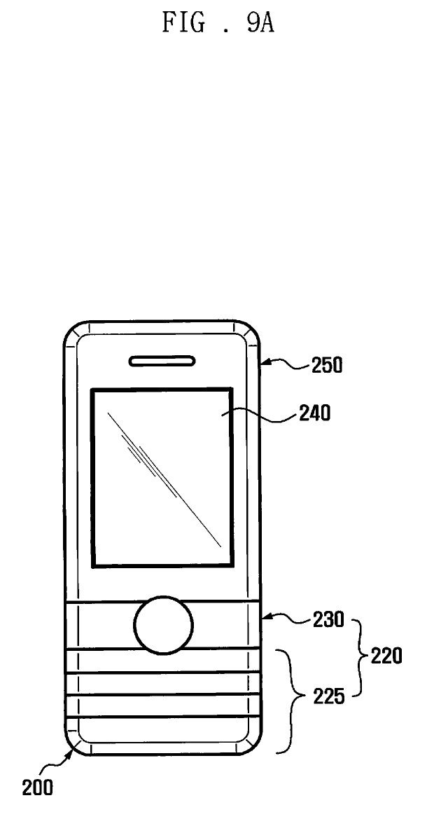

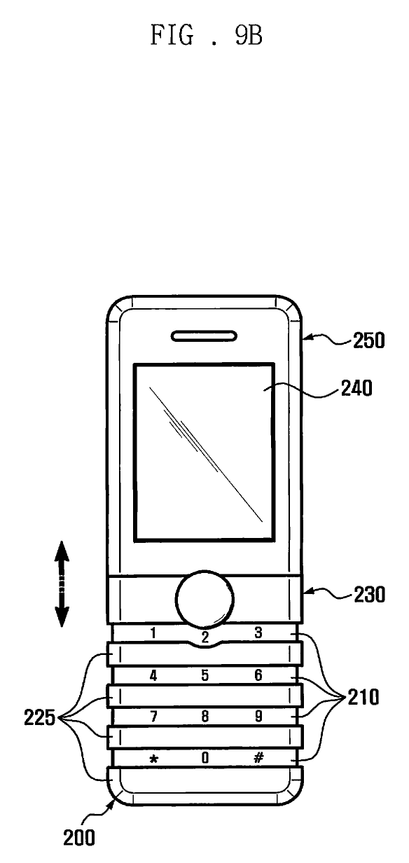

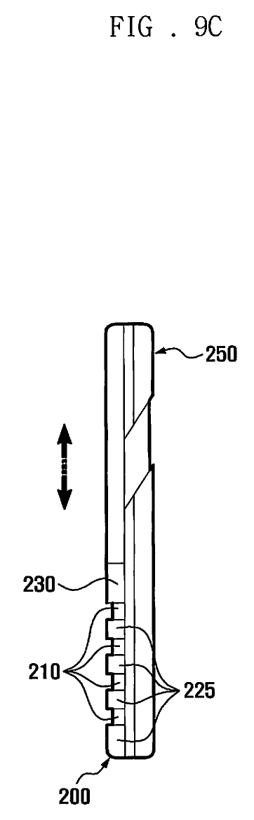

FIG. 9A illustrates a retracted state of a slide type mobile terminal having an extendable sliding module according to a fifth embodiment of the present invention, FIG. 9B illustrates an extended state of the slide type mobile terminal of FIG. 9A, and FIG. 9C illustrates the extended state of the slide type mobile terminal of FIG. 9A.

Referring to FIGS. 9A to 9C, the slide type mobile terminal includes a first main body 200, a second main body 250 disposed at an upper part of the first main body 200 and that can be extended and retracted while contacting the first main body 200, a plurality of plates 220 connected to the second main body 250, and a display unit 240 formed in the second main body 250. The plurality of plates 220 includes a plurality of key plates 225 and a function key 230. In a lower surface of the first main body 200, a key display unit 210 is formed. The first main body 200 may include the controller 109, the memory unit 107, and a microphone, and the second main body 250 may include a speaker.

FIG. 9A illustrates a retracted state of the slide type mobile terminal. In the retracted state, because the plurality of plates 220 are disposed to contact each other, the key display unit 210 is not exposed, and the display unit 240, the plurality of key plates 225, and the function key 230 maintain a locked state.

FIG. 9B illustrates an extended state of the slide type mobile terminal. In the extended state, because the plurality of plates 220 are disposed at a predetermined separation, the key display unit 210 is exposed between the plurality of plates 220. In this case, the lock of the display unit 240, the key plate 225, and the function key 230 is released, and the function key 230 and the key display unit 210 may be illuminated to display a function of keys thereon.

FIG. 9C illustrates the extended state of the slide type mobile terminal. In the extended state, the second main body 250 extends while contacting the first main body 200, and the plurality of plates 220 extend to have a predetermined separation according to extension of the second main body 250.

In FIGS. 9A-9C, the extendable sliding module is applied to a slide type mobile terminal, however the module is not limited thereto and can be applied to other types of mobile terminal.

In FIGS. 9A-9C, the mobile terminal extends and retracts through a user applying a physical force to a plate, however the present invention is not limited thereto. For example, the present invention may have a switch for automatically extending and retracting a mobile terminal.

As described above, by providing sufficient space between key plates, a user can more conveniently manipulate a key. Further, by performing a method such as illumination of the extended spaces, the mobile terminal can be designed to have various attractive appearances.

Moreover, plates can be extended to have a predetermined separation through an interlock operation of a structure having a plurality of plates, bars, and a plurality of links by sliding movement.

Although the preferred embodiments of the present invention have been described in detail hereinabove, it should be clearly understood that many variations and modifications of the basic inventive concepts herein described, which may appear to those skilled in the art, will still fall within the spirit and scope of the preferred embodiments of the present invention as defined in the appended claims.

What is claimed is:

1. An extendable sliding module, comprising:
a main body;
a plurality of plates disposed at an upper part of the main body and movable in a longitudinal direction thereof;
a guide groove formed in at least one of opposite side surfaces of the main body and extending in the longitudinal direction thereof; and
a hinge having one side slidably housed in the guide groove and the other side attached to the plurality of plates, and being extendable and retractable by a sliding movement between a first retracted state in which the plurality of plates are disposed to contact each other in the longitudinal direction of the main body and a second extended state in which the plurality of plates are disposed at a predetermined separation from each other.

2. The extendable sliding module of claim 1, wherein the hinge comprises:
a bar having a plurality of first members, each attached at one side to one of the plurality of plates, and a plurality of second members disposed within the plurality of first members; and
a plurality of links rotatably connected by a plurality of pins, each link having one end slidably housed in the guide groove and the other end attached to one of the plurality of first members,
wherein when the plurality of plates move between the first state and the second state, the bar and the plurality of links extend and retract in the movement direction by an interlock operation, and the bar moves in a direction perpendicular to the movement direction according to the extension and retraction of the plurality of links.

3. The extendable sliding module of claim 2, wherein each of the plurality of first members has an inwardly protruding first latch jaw formed at both ends thereof, and each of the plurality of second members has an outwardly protruding second latch jaw formed at both ends thereof, and
when the plurality of plates slide to the second state, the first latch jaw and the second latch jaw latch with each other.

4. The extendable sliding module of claim 2, wherein each of the plurality of first members has a hole in an outer surface thereof, and the plurality of links are attached to the first members by coupling the pin at one end of the link to the hole of the corresponding first member.

5. The extendable sliding module of claim 2, further comprising:
a plurality of spring members for connecting the plurality of second members;
a groove formed at the inside of one of the plurality of plates; and
an elastic deformable protrusion formed in at least one of the side surfaces of the main body,
wherein when the module slides to the second state, the protrusion connects to the groove, and when the protrusion is separated from the groove, the module slides to the first state by an elastically restoring force of the plurality of second members.

6. The extendable sliding module of claim 1, wherein the hinge comprises:
a plurality of first members, each having one side slidably housed in the guide groove and the other side attached to one of the plurality of plates; and
a plurality of second members disposed within the plurality of first members,
wherein the plurality of second members are enclosed by the plurality of first members in the first state and are exposed between the plurality of first members in the second state.

7. The extendable sliding module of claim 6, wherein each of the plurality of first members has an inwardly protruding first latch jaw formed at both ends thereof, and each of the plurality of second members has an outwardly protruding second latch jaw formed at both ends thereof, and
when the plurality of plates slide to the second state, the first latch jaw and the second latch jaw latch with each other.

8. The extendable sliding module of claim 1, further comprising:
a groove formed at the inside of one of the plurality of plates; and
an elastically deformable protrusion formed in at least one of both side surfaces of the main body,
wherein the hinge comprises a plurality of first members, each having one side slidably housed in the guide groove and the other side attached to one of the plurality of plates, and a plurality of second members for connecting the plurality of first members and having an elastic force, and
wherein when the module slides to the second state, the protrusion connects to the groove, and when the protrusion is separated from the groove, the module slides to the first state by an elastically restoring force of the plurality of second members.

9. The extendable sliding module of claim 1, wherein the module is a keypad module, and
each of the plurality of plates is a key plate having a quantity of key detection units.

10. The extendable sliding module of claim 1, wherein the main body is illuminated in the second state.

11. A mobile terminal comprising:
a first main body;
a second main body slidably disposed at an upper part of the first main body;
a plurality of key plates connected to the second main body;
a guide groove formed in at least one of opposite side surfaces of the first main body and extending in the longitudinal direction thereof; and
a hinge having one side slidably housed in the guide groove and the other side attached to the plurality of key plates, and being extendable and retractable by a sliding movement between a first retracted state in which the plurality of key plates are disposed to contact each other and a second extended state in which the plurality of key plates are disposed at a predetermined separation from each other.

12. The mobile terminal of claim 11, wherein the hinge comprises:
a bar having a plurality of first members, each attached at one side to one of the plurality of key plates, and a plurality of second members disposed within the plurality of first members; and
a plurality of links rotatably connected by a plurality of pins, each link having one end slidably housed in the guide groove and the other end attached to one of the plurality of first members,
wherein when the plurality of key plates move between the first state and the second state, the bar and the plurality of links extend and retract in the movement direction by an interlock operation, and the bar moves in a direction perpendicular to the movement direction according to the extension and retraction of the plurality of links.

13. The mobile terminal of claim 12, wherein each of the plurality of first members has an inwardly protruding first latch jaw formed at both ends thereof, and each of the plurality of second members has an outwardly protruding second latch jaw formed at both ends thereof, and
when the plurality of key plates slide to the second state, the first latch jaw and the second latch jaw latch with each other.

14. The mobile terminal of claim 12, wherein each of the plurality of first members has a hole in an outer surface thereof, and the plurality of links are attached to the first members by coupling the pin at one end of the link to the hole of the corresponding first member.

15. The mobile terminal of claim 11, wherein the hinge comprises:
a plurality of first members, each having one side slidably housed in the guide groove and the other side attached to one of the plurality of key plates; and
a plurality of second members disposed within the plurality of first members,
wherein the plurality of second members are enclosed by the plurality of first members in the first state and are exposed between the plurality of first members in the second state.

16. The mobile terminal of claim 15, wherein each of the plurality of first members has an inwardly protruding first latch jaw formed at both ends thereof, and each of the plurality of second members has an outwardly protruding second latch jaw formed at both ends thereof, and
when the plurality of key plates slide to the second state, the first latch jaw and the second latch jaw latch with each other.

17. The mobile terminal of claim 11, wherein the first main body has a key display unit in an upper surface thereof, and the key display unit is exposed between the plurality of key plates in the second state.

18. The mobile terminal of claim 17, wherein the key display unit is illuminated in the second state.
